(19) United States
(12) Patent Application Publication
(10) Pub. No.: US 2012/0111969 A1
(43) Pub. Date: May 10, 2012

(54) Systems and Methodologies for Achieving Acoustic Cancellation in Synthetic Jet Ejectors

(75) Inventors: Raghavendran Mahalingam, Austin, TX (US); Stephen P. Darbin, Austin, TX (US); Matthew B. Ernst, Union Grove, WI (US)

(73) Assignee: Nuventix Inc.

(21) Appl. No.: 13/292,210

(22) Filed: Nov. 9, 2011

Related U.S. Application Data
(60) Provisional application No. 61/411,654, filed on Nov. 9, 2010.

(51) Int. Cl. B05B 1/08; G10K 11/16

(52) U.S. Cl. 239/102.1; 181/296

(57) ABSTRACT

A system is provided for producing synthetic jets. The system comprises a first synthetic jet ejector equipped with a first diaphragm which operates at a first frequency f₁, and a second synthetic jet ejector equipped with a second diaphragm which operates at a second frequency f₂. The first and second synthetic jet ejectors are positioned with respect to each other such that the sound intensity of at least one of the first and second synthetic jet ejectors is reduced through destructive interference, wherein f₁ and f₂ are out-of-phase by φ degrees, and wherein 20≦φ≦60.

### CROSS-REFERENCE TO RELATED APPLICATION

This application claims the benefit of U.S. Provisional Application No. 61/411,654, filed Nov. 9, 2010, having the same title and the same inventors, and which is incorporated herein by reference in its entirety.

### FIELD OF THE DISCLOSURE

The present disclosure relates generally to synthetic jet ejectors, and more particularly to systems and methodologies for achieving acoustic cancellation in synthetic jet ejectors.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile solution where thermal management is required at the local level. Frequently, synthetic jet ejectors are utilized in conjunction with a conventional fan based system. In such hybrid systems, the fan based system provides a global flow of fluid through the device being cooled, and the synthetic jet ejectors provide localized cooling for hot spots and also augment the global flow of fluid through the device by perturbing boundary layers.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques.

Further advances have been made in the art, both with respect to synthetic jet ejector technology in general and its applications. Some examples of these advances are described in U.S. 20070141453 (Mahalingam et al.), entitled “Thermal Management of Batteries using Synthetic Jets”; U.S. 20070127210 (Mahalingam et al.), entitled “Thermal Management System for Distributed Heat Sources”; U.S. 20070119575 (Glezer et al.), entitled “Synthetic Jet Heat Pipe Thermal Management System”; U.S. 20070119573 (Mahalingam et al.), entitled “Synthetic Jet Ejector for the Thermal Management of PCI Cards”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. 7,784,972 (Heffington et al.), entitled “Thermal Management System for LED Array”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; and U.S. Pat. No. 7,607,470 (Glezer et al.), entitled “Synthetic Jet Heat Pipe Thermal Management System”.

### BRIEF DESCRIPTION OF THE DRAWINGS

FIG. 1 is an illustration of a first embodiment of a system in accordance with the teachings herein which utilizes a speaker to cancel noise from a synthetic jet ejector.

FIG. 2 is an illustration of a second embodiment of a system in accordance with the teachings herein which utilizes destructive interference at the source to cancel one or more harmonics of the noise from synthetic jet ejectors.

FIG. 3 is a graph of noise level (in dB) as a function of frequency for the embodiment of FIG. 2.

FIG. 4 is a graph of tonality as a function of phase angle.

FIG. 5 is an illustration of a third embodiment of a system in accordance with the teachings herein which utilizes a phase difference or modulation between two or more actuators to cancel noise from a synthetic jet ejector.

FIG. 6 is a schematic diagram illustrating a method which may be used for input waveform shaping.

FIG. 7 is an A-weighting curve illustrated as sound intensity (in dB) as a function of frequency (in Hz).

FIG. 8 is an illustration of a circuit arrangement which may be utilized to reduce the effect of strong harmonic frequency components by generating an opposing signal with the same frequency as one of the harmonics.

FIG. 9 is an illustration of a circuit arrangement which may be utilized to reduce the effect of strong harmonic frequency components by generating an opposing signal with the same frequency as one of the harmonics, wherein the system constantly monitors and tunes the cancellation circuit for optimum performance.

FIG. 10 is an illustration of a circuit arrangement which may be utilized to reduce the effect of strong harmonic frequency components by generating an opposing signal with the same frequency as one of the harmonics, wherein the system uses single frequency noise cancellation with adaptive feedback.

FIG. 11 is an illustration of a prior art synthetic jet ejector which uses constructive interference for noise cancellation.

FIG. 12 is an illustration of a prior art synthetic jet ejector which uses constructive interference for noise cancellation.

FIG. 13 is a graph of phase angle as a function of amplitude for a device of the type depicted in FIG. 11.

### SUMMARY OF THE DISCLOSURE

In one aspect, a method for producing synthetic jets is provided. In accordance with the method, a first synthetic jet ejector is provided which is equipped with a first diaphragm which operates at a first frequency f₁, and a second synthetic jet ejector is provided which is equipped with a second diaphragm which operates at a second frequency f₂. The first and second synthetic jet ejectors are then positioned with respect to each other such that the sound intensity of the synthetic jet ejectors is reduced through destructive interference, wherein f₁ and f₂ are out-of-phase by φ degrees, and wherein 20≦φ≦60.

In another aspect, a system is provided for producing synthetic jets. The system comprises a first synthetic jet ejector equipped with a first diaphragm which operates at a first frequency f₁, and a second synthetic jet ejector equipped with a second diaphragm which operates at a second frequency f₂. The first and second synthetic jet ejectors are positioned with respect to each other such that the sound intensity of at least one of the first and second synthetic jet ejectors is reduced through destructive interference, wherein f₁ and f₂ are out-of-phase by φ degrees, and wherein 20≦φ≦60.

In a further aspect, a method for reducing the acoustical footprint of a synthetic jet ejector is provided. In accordance with the method, a synthetic jet ejector is provided which comprises a first diaphragm, and an acoustical speaker is provided which comprises a second diaphragm. The synthetic jet ejector is then operated such that the first diaphragm vibrates at a first frequency f₁, and the acoustical speaker is operated such that the second diaphragm vibrates at a second frequency f₂. The acoustical speaker is positioned with respect to the synthetic jet ejector such that the sound intensity of the synthetic jet ejector is reduced through destructive interference between the first and second frequencies.

In yet another aspect, a system for producing synthetic jets is provided. The system comprises a synthetic jet ejector equipped with a first diaphragm which operates at a first frequency f₁, and an acoustical speaker equipped with a second diaphragm which operates at a second frequency f₂. The acoustical speaker is adapted to reduce the sound intensity of the synthetic jet ejector through destructive interference.

In still another aspect, a method is provided for reducing the acoustical footprint of a synthetic jet actuator. The method comprises (a) determining the velocity output of the synthetic jet actuator; (b) determining a transform G(z) which operates on the input of the synthetic jet actuator to produce the velocity output; (c) calculating an inverse transform G′(z) corresponding to G(z); (d) verifying G′(z) by reproducing the actuator input from the velocity output; and (e) using G′(z) to determine an input for the synthetic jet actuator which will reduce the acoustical footprint of the synthetic jet actuator.

### DETAILED DESCRIPTION

Despite the many advances noted above, challenges still remain in the commercial implementation of synthetic jet ejector technology. For example, some synthetic jet ejectors are plagued by a significant acoustical footprint. This shortcoming is particularly troublesome in certain applications, such as the thermal management of laptop computers, handheld communications devices such as PDAs or cellular phones, or other consumer devices, because background noise in these devices is increasingly regarded as being highly objectionable by the user. This problem has been exacerbated by recent successes in noise reduction in many of the common electronic components of these devices, such as hard drives, PCBs and chipsets. In particular, in previous generations of these devices, the background noise created by such components might have otherwise masked any acoustical footprint associated with a synthetic jet ejector being used to provide thermal management for the host device. In current iterations of these devices, however, any audible noise produced by a synthetic jet ejector is readily noticeable.

Some attempts have been made in the art to address this issue. By way of example, U.S. 2008/0006393 (Grimm) describes a vibration isolation system for synthetic jet ejectors. The use of such devices may reduce or eliminate noise arising from the vibrations produced by synthetic jet ejectors.

Another approach to the foregoing problem is represented in U.S. 2005/0121171 (Mukasa et al.). This reference discloses an air jet flow generating apparatus 1 equipped with vibrating mechanisms 5, 6 which are disclosed in respective casings 11, 12 equipped with respective sets of nozzles 13, 14. The air flow created by the air jet flow generating apparatus 1 is directed to a heat sink comprising a heat spreader 51 having a plurality of heat radiation fins 52 disposed thereon. An IC chip 50 is disposed on one surface of the heat spreader 51.

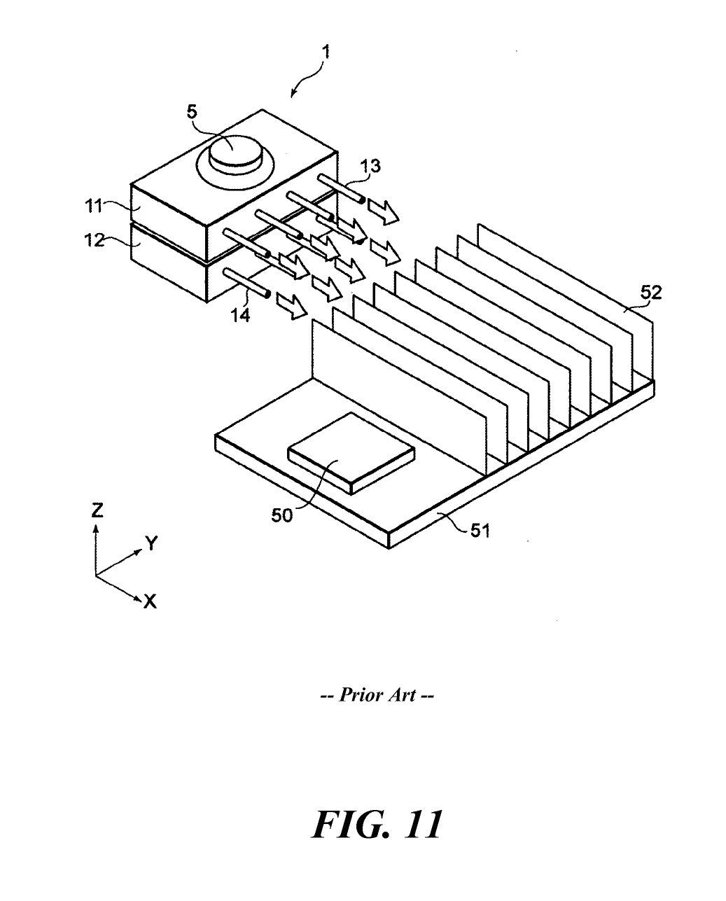

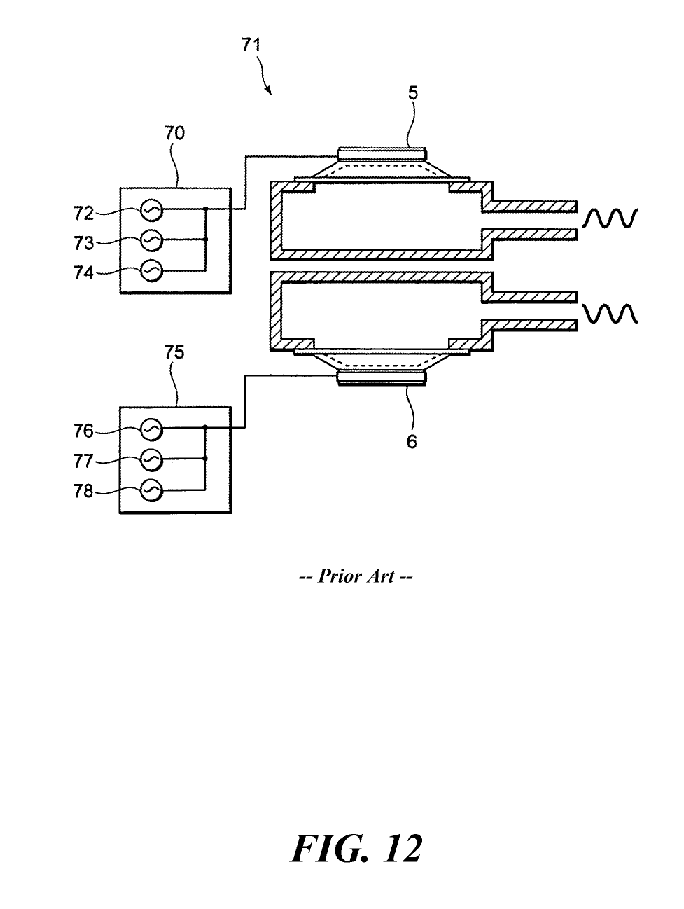

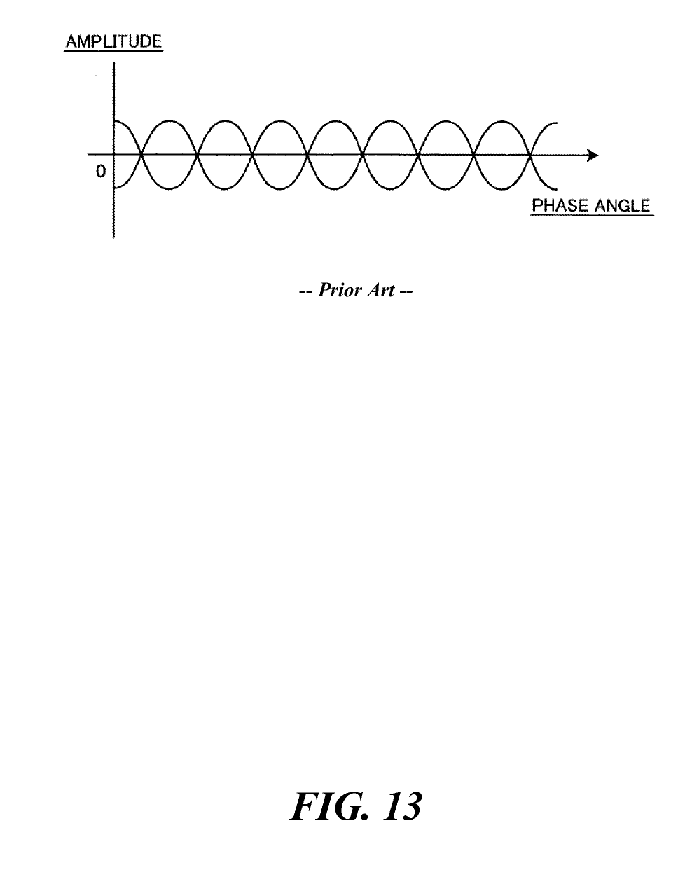

With reference to FIG. 12, vibrating mechanisms 5, 6 are equipped with respective vibration control units 70, 75 having respective drive signal sources 72, 73, 74 and 76, 77, 78. In operation, the vibrating mechanisms 5, 6 in the device depicted in FIGS. 11-12 are operated out of phase to provide noise cancellation. As seen in the graph of FIG. 13, the synthetic jet ejectors in this device are operated 90° out of phase.

While the foregoing approaches may provide some noise reduction in the operation of synthetic jet ejectors or similar devices in some applications, a need exists in the art for further improvements in noise cancellation. It has now been found that this need may be addressed by the systems and methodologies disclosed herein.

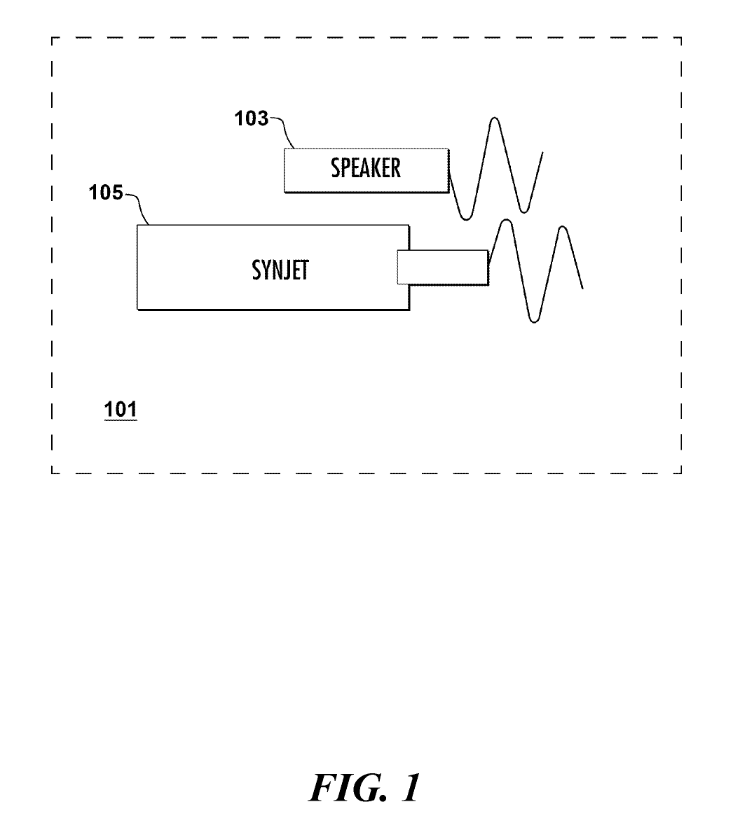

FIG. 1 illustrates a first particular, non-limiting embodiment of a system in accordance with the teachings herein. The system 101 depicted therein comprises an acoustical speaker 103 and a synthetic jet ejector 105. The acoustical speaker 103 and the synthetic jet ejector 105 have primary frequencies f₁ and f₂ associated with them, respectively. Preferably, f₁ and f₂ are equal in amplitude and frequency but are out of phase with each other. During operation, frequencies f₁ and f₂ cancel out through destructive interference, thus reducing the acoustical footprint of the device.

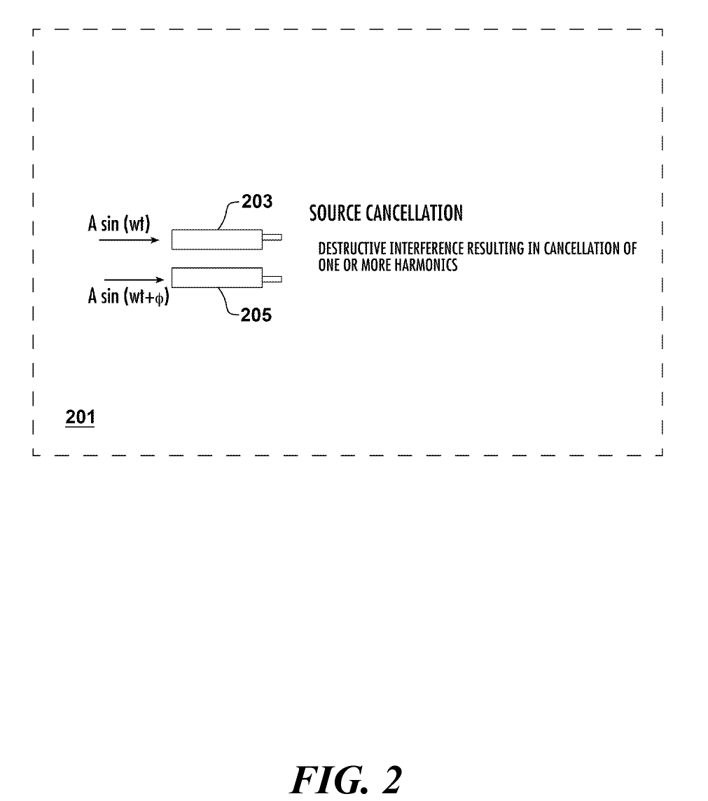

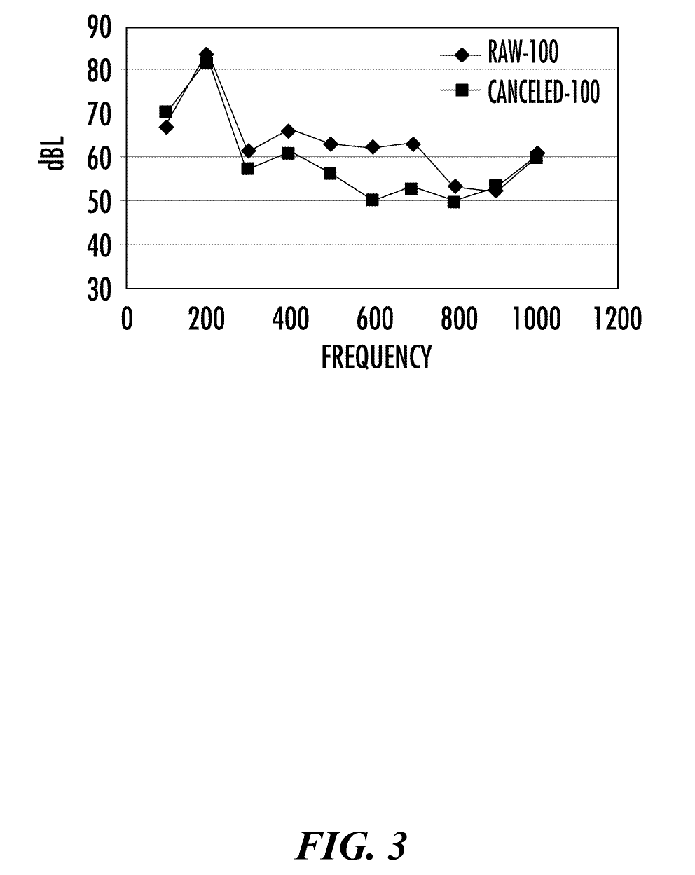

FIGS. 2-3 illustrate a second particular, non-limiting embodiment of a system in accordance with the teachings herein. The system 201 depicted therein comprises a first synthetic jet ejector 203 and a second synthetic jet ejector 205. The first 203 and second 205 synthetic jet ejectors have primary frequencies f₁ and f₂ associated with them, respectively. Preferably, f₁ and f₂ are equal in amplitude and frequency, but are out of phase with each other.

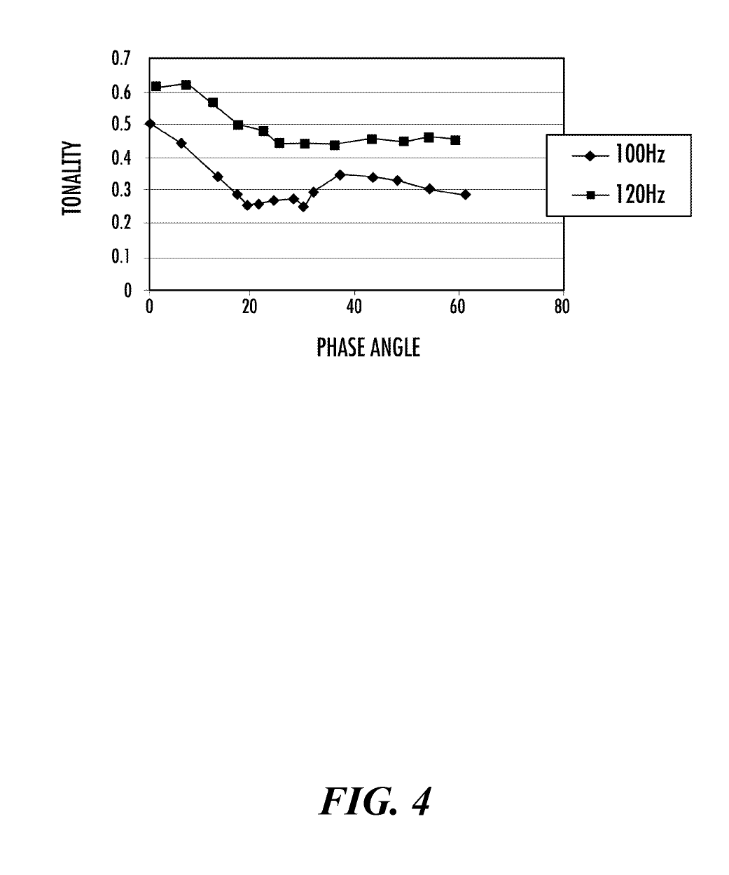

As seen in the graphs of FIGS. 3 and 4, the arrangement depicted in FIG. 2 achieves a notable decrease in both noise and tonality. Surprisingly, as shown in FIG. 4, optimal results are not achieved by operating the synthetic jet ejectors exactly out of phase as might be expected, but are instead achieved by operating the synthetic jet ejectors out of phase by an amount within the range of about 20° to about 60°, preferably by an amount within the range of about 30° to about 50°, more preferably within the range of about 35° to about 45°, and most preferably by about 40°.

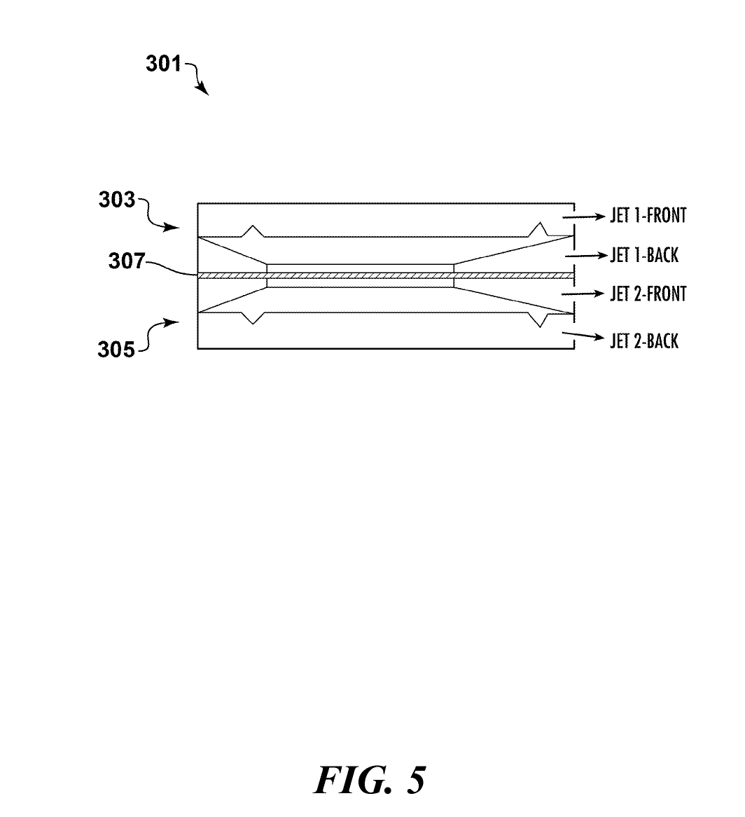

The foregoing approach is preferably implemented by using a synthetic jet ejector 301 of the type shown in FIG. 5, in which the cavities of the individual synthetic jet ejectors 303, 305 are separated from each other by a wall or other suitable partition 307. Such a configuration (which, in this particular, non-limiting embodiment, emits synthetic jets from both the front and back of the diaphragm) allows the harmonics produced by the individual actuator flows to be mitigated by using a phase difference or modulation between the actuators 303, 305. The decrease in tonality achievable with such a configuration has been noted above with reference to FIG. 4.

The noise heard by the user during operation of a synthetic jet ejector is a combination of broadband noise and strong frequency components. The broadband noise is generally caused by turbulent air at the jet nozzles. The strong frequency components are harmonics of the fundamental operating frequency of the synthetic jet ejector, and are created by resonances within the cavity of the host device. When an actuator is operated in free air (i.e., without an actuator housing), the level of these harmonics is low. However, the magnitude of these harmonics increases after the actuator is placed within the cavity of a housing or host device.

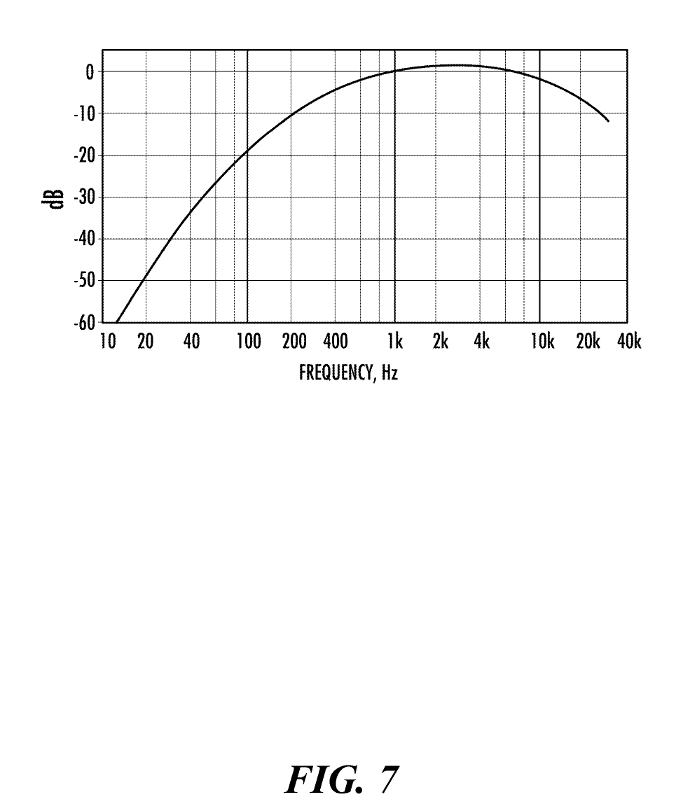

The fundamental frequency of the synthetic jet ejector is generally kept below 100Hz to minimize the psycho-acoustic effect on loudness. This psycho-acoustic effect is characterized by the A-Weighting curve, an example of which is shown in FIG. 7 for a typical synthetic jet actuator. The harmonics generated as a result of the disposition of the actuator in the cavity of the host device can have significant amplitude and range from 2× to 10× the fundamental frequency. Since these harmonics fall within the higher region of the A-weighting curve, there is a larger and undesirable penalty in the “perceived loudness” of the synthetic jet ejector associated with them.

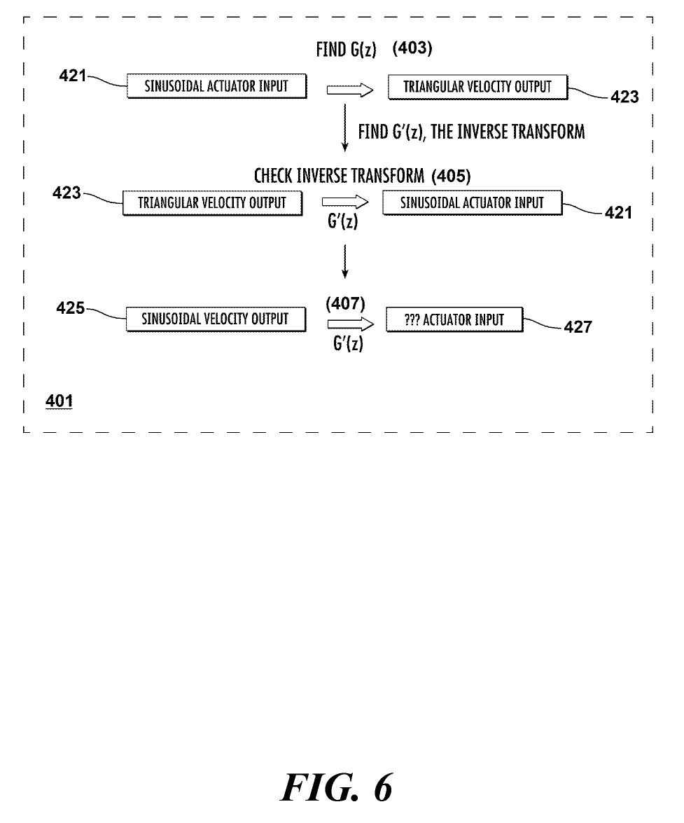

FIG. 6 illustrates a particular, non-limiting embodiment of a method which may be utilized for input waveform shaping to address the foregoing issue. As seen therein, the method 401 involves determining 403 a transform G(z) which operates on the sinusoidal actuator input 421 to produce a triangular velocity output 423. The inverse of the transform G′(z) is then determined and verified by reproducing 405 the sinusoidal actuator input 421 from the triangular velocity output 423. Once verified, the inverse transform may be applied 407 to the sinusoidal velocity output 425 to determine an actuator input 427 required to produce the desired noise cancellation.

Using the foregoing approach, the effect of the strong harmonic frequency components may be reduced by modifying the synthetic jet ejector driver circuitry to generate an opposing signal with the same frequency as one of the harmonics. This opposing signal may be generated with a phase and amplitude that opposes that of the harmonic generated inside the housing of the host device so that, when the two combine, the result is as close to null as possible. The phase and amplitude of this opposing signal may be determined by the cavity dynamics of the particular host device or synthetic jet ejector housing. Once this opposing signal is generated, it may be added to the fundamental drive signal, amplified and then sent to the synthetic jet ejector actuators.

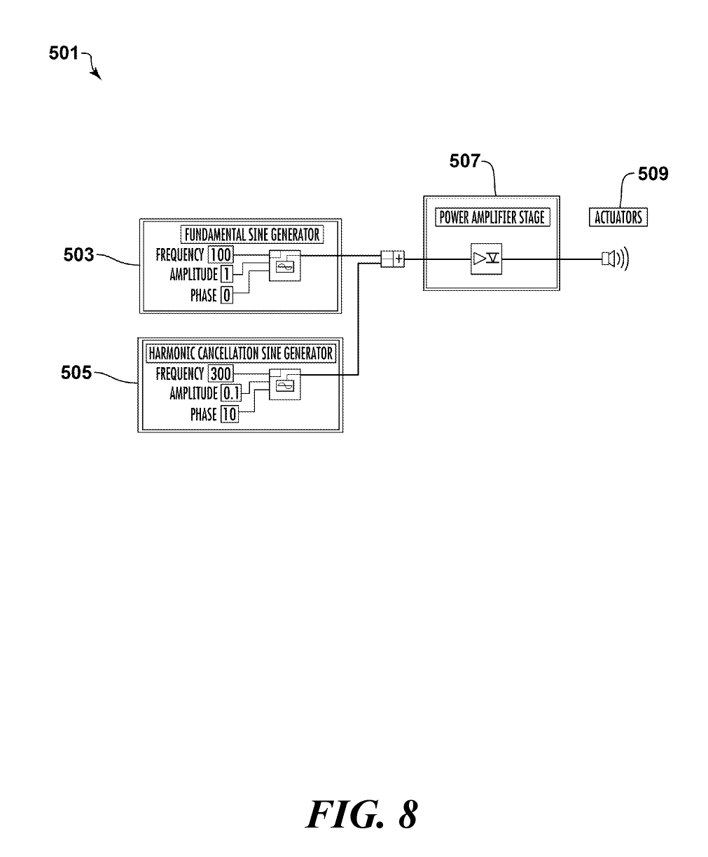

FIG. 8 is an illustration of a circuit arrangement which may be utilized to reduce the effect of strong harmonic frequency components by generating an opposing signal with the same frequency as one of the harmonics. As seen therein, the circuit arrangement 501 comprises a fundamental sine generator 503, a harmonic cancellation sine generator 505, a power amplifier stage 507, and one or more actuators 509. The particular arrangement illustrated may be used for single frequency noise cancellation.

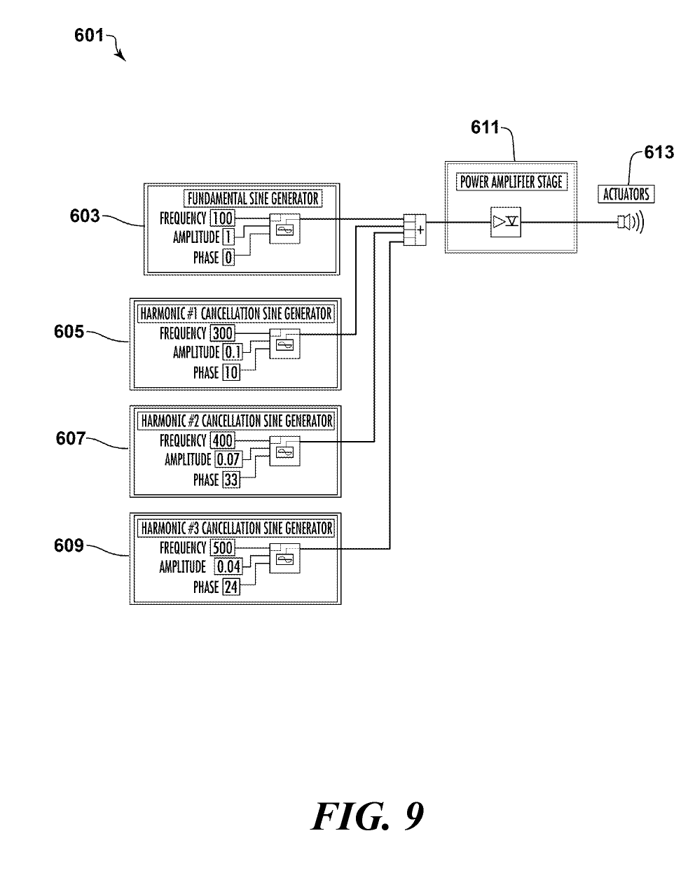

The technique implemented by the circuit arrangement of FIG. 8 may be extended to target multiple strong frequency components in the noise signal by increasing the number of generators. FIG. 9 is a block diagram of such a system that cancels multiple fundamentals. As seen therein, the circuit arrangement 601 comprises a fundamental sine generator 603, first 605, second 607 and third 609 harmonic cancellation sine generators, a power amplifier stage 611, and one or more actuators 613. The system of FIG. 9 reduces the effect of strong harmonic frequency components by generating an opposing signal with the same frequency as one of the harmonics, wherein the system constantly monitors and tunes the cancellation circuit for optimum performance.

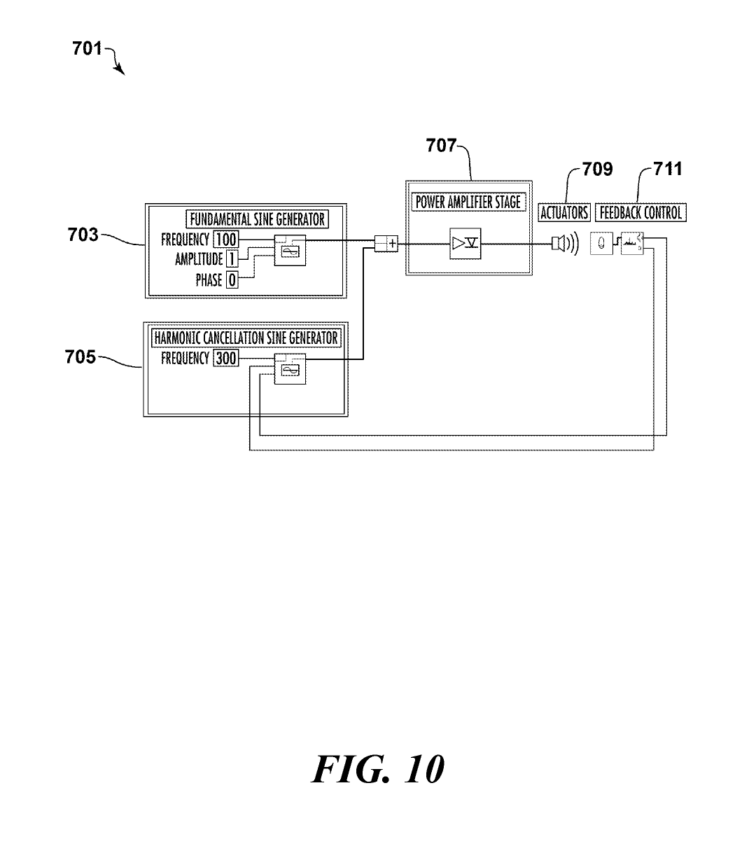

FIG. 10 is an illustration of a circuit arrangement which may be utilized to reduce the effect of strong harmonic frequency components by generating an opposing signal with the same frequency as one of the harmonics, wherein the system uses single frequency noise cancellation with adaptive feedback. As seen therein, the circuit arrangement 701 comprises a fundamental sine generator 703, a harmonic cancellation sine generator 705, a power amplifier stage 707, one or more actuators 709, and a feedback control 711. With the introduction of a sensing element inside the host device or synthetic jet ejector housing, the system can constantly monitor and tune the cancelation circuit for optimum performance. This type of closed loop noise cancellation circuit would preferably be used in dynamic operation situations that do not have a constant fundamental frequency, or that have varying cavity dynamics for other reasons.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A system for producing synthetic jets, comprising:
a synthetic jet ejector comprising a first diaphragm which operates at a first frequency f₁; and
an acoustical speaker comprising a second diaphragm which operates at a second frequency f₂;
wherein the acoustical speaker is adapted to reduce the sound intensity of the synthetic jet ejector through destructive interference.

2. The system of claim 1, wherein f₁ and f₂ are the same frequency.

3. The system of claim 2, wherein f₁ and f₂ have the same amplitude.

4. The system of claim 3, wherein f₁ and f₂ are out-of-phase.

5. The system of claim 3, wherein f₁ and f₂ are out-of-phase by φ degrees, and wherein 20≦φ≦60.

6. The system of claim 3, wherein f₁ and f₂ are out-of-phase by φ degrees, and wherein 30≦φ≦50.

7. The system of claim 3, wherein f₁ and f₂ are out-of-phase by φ degrees, and wherein 35≦φ≦45.

8. A method for reducing the sound intensity of a synthetic jet ejector, comprising:
providing a synthetic jet ejector comprising a first diaphragm;
providing an acoustical speaker comprising a second diaphragm;
operating the synthetic jet ejector such that the first diaphragm vibrates at a first frequency f₁; and
operating the acoustical speaker such that the second diaphragm vibrates at a second frequency f₂;
wherein the acoustical speaker is positioned with respect to the synthetic jet ejector such that the sound intensity of the synthetic jet ejector is reduced through destructive interference between the first and second frequencies.

9. The method of claim 8, wherein f₁ and f₂ are the same frequency.

10. The method of claim 9, wherein f₁ and f₂ have the same amplitude.

11. The method of claim 10, wherein f₁ and f₂ are out-of-phase.

12. The method of claim 10, wherein f₁ and f₂ are out-of-phase by φ degrees, and wherein 20≦φ≦60.

13. The method of claim 10, wherein f₁ and f₂ are out-of-phase by φ degrees, and wherein 30≦φ≦50.

14. The method of claim 10, wherein f₁ and f₂ are out-of-phase by φ degrees, and wherein 35≦φ≦45.

15. A system for producing synthetic jets, comprising:
a first synthetic jet ejector equipped with a first diaphragm which operates at a first frequency f₁; and
a second synthetic jet ejector equipped with a second diaphragm which operates at a second frequency f₂;
wherein the first and second synthetic jet ejectors are positioned with respect to each other such that reduce the sound intensity of the synthetic jet ejector through destructive interference, wherein f₁ and f₂ are out-of-phase by φ degrees, and wherein 20≦φ≦60.

16. The system of claim 15, wherein f₁ and f₂ are out-of-phase by φ degrees, and wherein 30≦φ≦50.

17. The system of claim 15, wherein f₁ and f₂ are out-of-phase by φ degrees, and wherein 35≦φ≦45.

18. A method for producing synthetic jets, comprising:
providing a first synthetic jet ejector equipped with a first diaphragm which operates at a first frequency f₁, and a second synthetic jet ejector equipped with a second diaphragm which operates at a second frequency f₂; and
positioning the first and second synthetic jet ejectors with respect to each other such that the sound intensity of the synthetic jet ejectors is reduced through destructive interference, wherein f₁ and f₂ are out-of-phase by φ degrees, and wherein 20≦φ≦60.

19. The method of claim 18, wherein f₁ and f₂ are out-of-phase by φ degrees, and wherein 30≦φ≦50.

19. The method of claim 18, wherein f₁ and f₂ are out-of-phase by φ degrees, and wherein 35≦φ≦45.

20. A method for reducing the acoustical footprint of a synthetic jet ejector having a synthetic jet actuator, comprising:
determining the velocity output of the synthetic jet ejector;
determining a transform G(z) which operates on the input to the synthetic jet actuator to produce the velocity output;
calculating an inverse transform G′(z) corresponding to G(z);
verifying G′(z) by reproducing the actuator input from the velocity output; and
using G′(z) to determine an input for the synthetic jet actuator which will reduce the acoustical footprint of the synthetic jet ejector.

21. The method of claim 20, wherein the actuator input is sinusoidal.

22. The method of claim 20, wherein reducing the acoustical footprint of the synthetic jet actuator involves reducing the tonality of the synthetic jet actuator.
